(19) United States
(12) Patent Application Publication
(10) Pub. No.: US 2013/0110786 A1
(43) Pub. Date: May 2, 2013

(54) DISTRIBUTED FILE SYSTEM AND METHOD OF SELECTING BACKUP LOCATION FOR THE SAME

(71) Applicant: Delta Electronics, Inc., Taoyuan County (TW)

(72) Inventor: Chih-Wei WU, Taoyuan County (TW)

(73) Assignee: DELTA ELECTRONICS, INC., Taoyuan County (TW)

(21) Appl. No.: 13/664,244

(22) Filed: Oct. 30, 2012

(30) Foreign Application Priority Data
Oct. 31, 2011 (TW) 100139520

(51) Int. Cl. G06F 17/30

(52) U.S. Cl. 707/654; 707/E17.01

(57) ABSTRACT

A method for selecting backup location used by a DFS is to prevent data lose or unavailable while a single point of failure of a switch occurs. The DFS comprises multiple switches and multiple servers. Each server respectively connected to each connection port of each switch and uses the assigned Internet Protocol (IP) address of the connection port. When the DFS generates at least one replica based on an original copy, the replica is stored in a server different from the server storing the original copy. The physical locations of servers are decided according to the IP address of the different servers. The present embodiment assures that the server for storing the original copy and the server for storing the replica are connected to different switches. Thus, either the original copy or the replica is accessible once a switch under the DFS fails.

This application is based on and claims the benefit of Taiwan Application No. 100139520 filed Oct. 31, 2011 the entire disclosure of which is incorporated by reference herein.

### BACKGROUND OF THE INVENTION

1. Field of the Invention

The present invention relates to a distributed file system (DFS), in particular, relates to a method for selecting a replicated location of replicas in the DFS.

2. Description of Prior Art

System administrators are allowed to simplify users' file access by using a DFS. A DFS integrates multiple files distributed among servers. Thus, the files seem to be stored on the same location of the network to users. The users are allowed to access to the files in ease without prior knowledge of physical locations of the files during file access.

The DFS typically has multiple switches, and each switch respectively connects to multiple servers, whereby multiple servers are integrated into an independent macro system. Users connect to the DFS and gain access to the files stored in each server under the DFS and do not need to know the physical address and connection status of each server.

Typically, the DFS uses a File Replication Service (FRS) for automatically generating at least one replica based on an original copy in order to optimize the data security of the original copy, and to prevent data lose or unavailable while the server for storing the original copy fails.

When the DFS generates the replica, the server used for storing the replica is traditionally assigned by random algorithm calculation or selected based on a hard code setup by administrators. Generally, the server for storing the replica is different from the server for storing the original copy. Accordingly, when the server for storing the original copy failed, the DFS directly changes the access routes and users are guided to connect with another server to access to the replica of the original copy. Thus, it is convenient that users are not impacted while the failure of the server and are allowed to access to the replicas instead of the original copy.

However, the switches which servers connected with may fail in addition to the servers. When single point of failure of a switch occurs, the multiple servers connected to the failed switch immediately become inaccessible. For example, if an original copy is stored in a first server, the replica of the original copy is stored in a second server, and the first server and the second server both connected to a first switch, the first server and the second server both will become inaccessible once the first switch fails. As a result, both the original copy and the replica are unavailable.

In order to prevent the circumstance above, multiple DFSs in the market generally use additional applications or hardware as protection mechanisms for minimizing switch failures and sending warning messages to system administrators while the failure occurs. However, a DFS usually has multiple switches, therefore, it is a high-priced cost if the protection mechanisms mentioned above is used for all switches in the DFS.

In terms of the above problems, an innovative mechanism is desirable in the market to address the issues, where a DFS automatically selects a best and safest replicated location for storing replicas so as to assure that either original copy or replica is accessible once a switch under the DFS fails without adding additional protection mechanisms to the switch. Accordingly, the system setup cost is lowered.

### SUMMARY OF THE INVENTION

The objective of the present invention is to provide a method to select a replicated location for a DFS to prevent data lose or unavailable while single point of failure of switch occurs. Thus it is assured that either original copy or replicas are accessible once a switch under a DFS fails, and the multiple servers connected to the failed switch immediately become inaccessible.

In order to achieve the purpose above, the present invention provides a DFS comprising a plurality of switches and a plurality of servers. Each server respectively connects to a connection port of each switch for using an assigned Internet Protocol (IP) address of the connection port.

When the DFS generates at least one replica based on an original copy, the IP address used by each server is used for deciding the physical location of each server. The original copy is stored in one server and the replica is stored in a different location of another server. This method is to make sure the server for storing the original copy and the server for storing the replicas are connected to different switches.

Compare to prior art, the advantage of the present invention is that the IP address of each server is used for determining the connection port of the switch that the server physically connected with. Accordingly, when the DFS generates at least one replica to store in a server, the system screens and selects a server for storing the replica. As a result, it is assured that the server for storing the replica and the server for storing the original copy connects to different switches. The advantage relies on that users can access to either the original copy or the replicas when one of the switches under the DFS fails and multiple servers under the failed switch immediately become inaccessible. Accordingly, users are allowed to access to either the original copy or the replicas once instead of unable to access to the original copy or the replicas completely once a server fails or the switch which the servers connected with fails.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is a system architecture diagram of a preferred embodiment according to the present invention;

FIG. 2 is a topology schematic diagram of a preferred embodiment according to the present invention;

FIG. 3 is a topology schematic diagram of another preferred embodiment according to the present invention;

FIG. 4 is a topology schematic diagram of the other preferred embodiment according to the present invention;

FIG. 5 is a flow chart of a preferred embodiment according to the present invention;

FIG. 6 is a flow chart of a preferred embodiment according to the present invention; and

FIG. 7 is a schematic diagram for assigning IP address of a preferred embodiment according to the present invention.

### DETAILED DESCRIPTION OF THE INVENTION

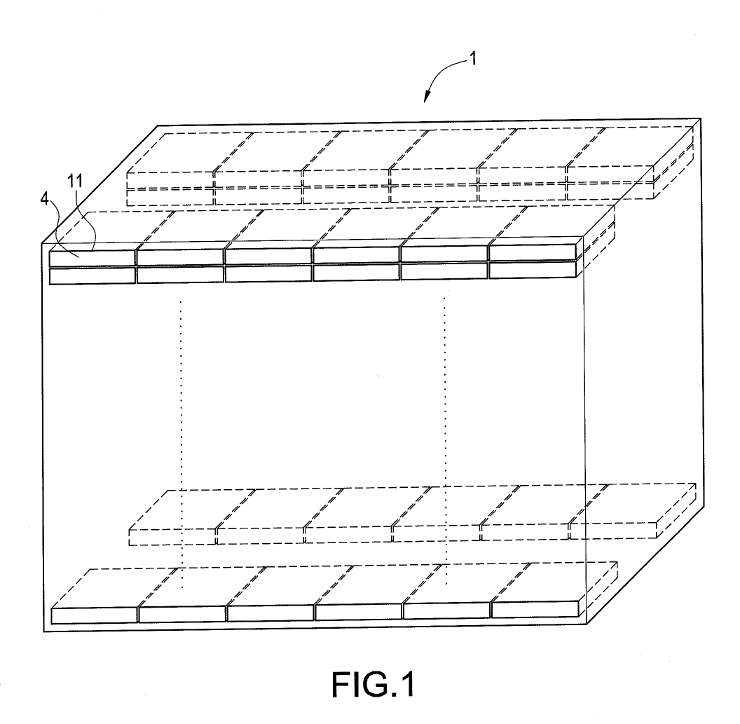

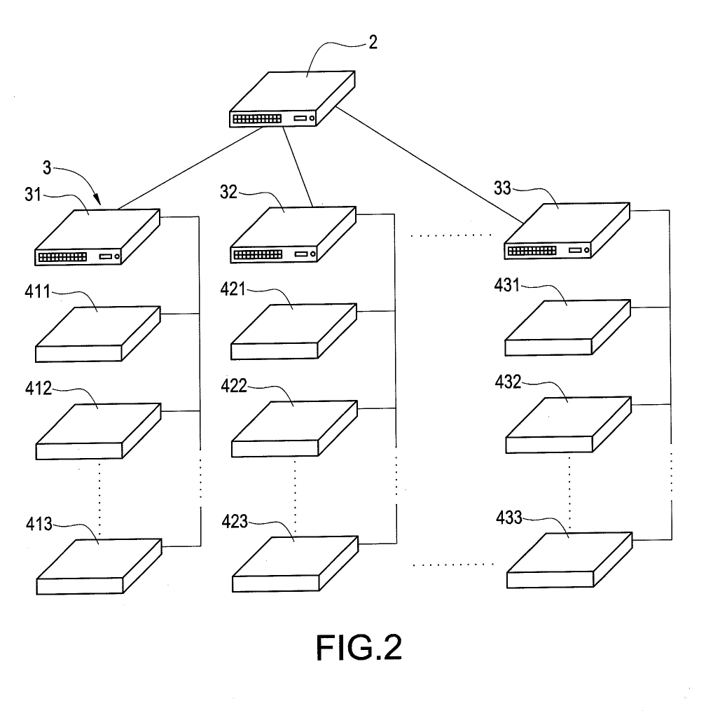

FIG. 1 is a system architecture diagram of a preferred embodiment according to the present invention. The system cabinet 1 of a DFS is shown in FIG. 1. The system cabinet 1 consists of multiple server slots 11. Each server 4 is able to slide into a server slot 11 respectively. Multiple switches are initially installed in the system cabinet 1 (for example, the main switch 2, the first switch 31, the second switch 32, and the Nth switch 33 in FIG. 2) and are respectively used for connecting to each server 4 and integrate all servers 4 to form a data center.

In FIG. 1, each layer of the system cabinet 1 is divided into at least but not limited to twelve server slots 11 (six servers in the front end and another six servers in the back), and the system cabinet 1 has forty layers. There are up to 12*40=480 servers 4 in the system cabinet 1. However the above mentioned is one of the preferred embodiment according to the present invention. The system cabinet 1 can be configured into different form factors with capacities depending on the requirements of each case, and is not limited to.

In the embodiment, the DFS uses the Layer-2/Layer-3 switch architecture. Multiple Layer-2/Layer-3 switches 3 are located on Layer-2/Layer-3 (the first switch 31, the second switch 32, and the Nth switch 33 shown in FIG. 2) has multiple connection ports, and each connection port is respectively assigned an Internet Protocol (IP) address. The IP address can be a fixed IP or a dynamic IP assigned by a Dynamic Host Configuration Protocol (DHCP). After each IP address is assigned, it does not change. In other words, it's a one to one mapping between the IP address and assigned connection port. When a server 4 slides in a server slot 11 of the system cabinet 1, the server 4 in the server slot 11 connects to a connection port of the Layer-2/Layer-3 switch 3 via physical wire. The server 4 uses assigned IP address of the connection port to connect to the network.

However, the assigned IP address of each connection port on each Layer-2/Layer-3 switch 3 does not change. The assigned IP address is varied depending on the network topology used by the DFS. The assigned IP address will be changed when network topology of the switches are changed.

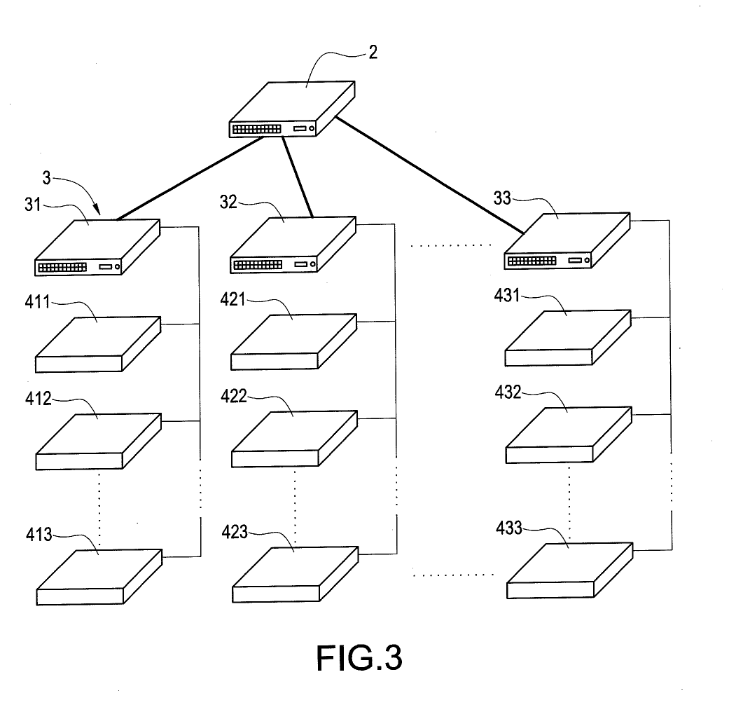

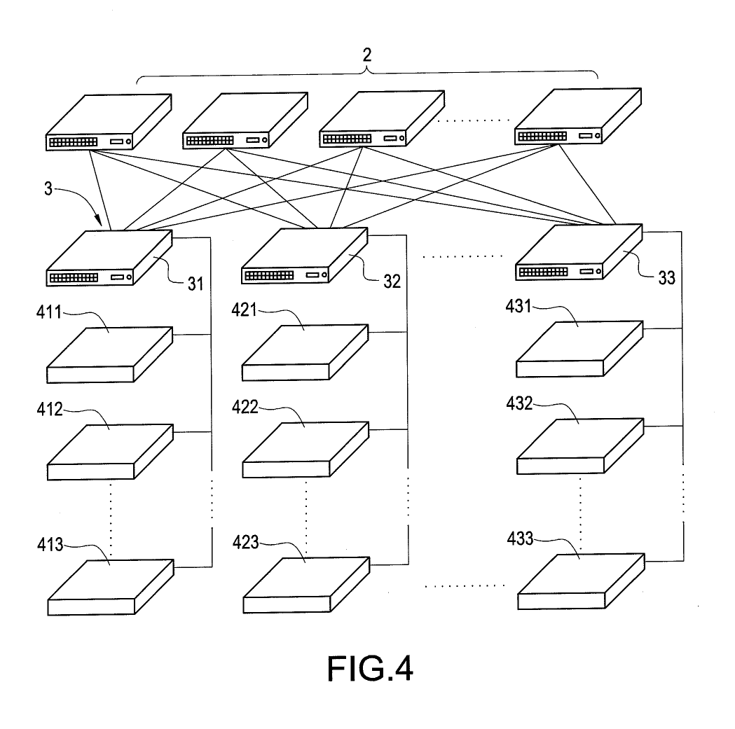

FIG. 2, FIG. 3, and FIG. 4 are topology schematic diagrams of a preferred embodiment, another preferred embodiment, and the other preferred embodiment according to the present invention. FIG. 2 demonstrates a tree topology architecture. In the embodiment, the DFS has a main switch 2. The main switch 2 connects to multiple Layer-2/Layer-3 switches 3 via multiple connection ports of the main switch 2. Each Layer-2/Layer-3 switch 3 respectively connects to multiple servers 4 via the plurality of connection ports of each Layer-2/Layer-3 switch 3 (as shown in the diagram, the first switch 31 connects to the servers 411, 412, 413 via physical wire; the second switch 32 connects to the servers 421, 422, 423 via physical wire; and the third switch 33 connects to the servers 431, 432, 433 via physical wire).

In the embodiment shown in FIG. 2, the main switch 2 connects to three Layer-2/Layer-3 switches 3. Each Layer-2/Layer-3 switch 3 respectively connects to three servers 4. The amount of the Layer-2/Layer-3 switches 3 depends on, but not limited to, the amount of the connection ports of the main switch 2, and the amount of the servers 4 which each Layer-2/Layer-3 switch 3 respectively connects with depends on, but not limited to, the amount of the connection ports of each Layer-2/Layer-3 switch 3.

FIG. 3 is a topology schematic diagram of another preferred embodiment according to the present invention. Tree topology with trunking architecture is similar with the tree topology architecture shown in FIG. 2. The difference lies in that each Layer-2/Layer-3 switch 3 combines two or more than two connection ports into one logical route to connect with the main switch 2 via physical wire. Thus, the bandwidth used by the connection ports using the same logical route is shared and the bandwidth between the main switch 2 and each Layer-2/Layer-3 switch 3 is increased. Accordingly, the tree topology with trunking architecture provides faster transmission speeds in a DFS.

FIG. 4 is a topology schematic diagram of the other preferred embodiment according to the present invention. If a DFS adapts mesh topology architecture, the DFS has multiple main switches 2 on the first layer and multiple Layer-2/Layer-3 switches 3 on the second layer. Each main switch 2 respectively connects to all Layer-2/Layer-3 switches 3 via physical wire, and each Layer-2/Layer-3 switch 3 also connects to each main switch 2.

As mentioned above, the advantage of adapting mesh topology is that multiple connections delivers higher data transmission rates and results in less signal attenuation. Also, each main switch 2 of the first layer and each Layer-2/Layer-3 switch 3 of the second layer are interconnected. It is easier to administrators to maintain systems.

Generally speaking, when a DFS stores an original copy, the DFS also generates at least one replica via file replication service (FRS) in order to assure file security and stability. The selection of a replicated location of the replica is a critical issue in a DFS. Not only that the original copy is stored in one server, and the replica is required to store in a different location of another server, also it is important to assure that either the original copy or the replica is accessible once one of the Layer-2/Layer-3 switch 3 fails, and the multiple servers 4 connected to the failed switch immediately become inaccessible.

The present invention provides an ideal solution to select a replicated location, and to prevent data lose or unavailable while single point of failure of the Layer-2/Layer-3 switches 3 occurs. Beginning knowing the topology architecture adapted by the DFS, the topology architecture is used for inferring the connected status of each server 4 and each Layer-2/Layer-3 switch 3, and the IP address used by each server 4. Thus, the connection status of each server 4 and each Layer-2/Layer-3 switch 3 is used as a reference when selecting a replicated location of a replica in order to prevent that the server for storing the original copy, and the server for storing the replica are connected to the same Layer-2/Layer-3 switch 3.

For example, the original copy is stored in the server 411, the replica is stored in the server 413, and the servers 411 and 413 are both connected to the first switch 31 via physical wire. Under the circumstance, if the first switch 31 fails, the server 411 and 413 connected to the failed first switch 31 immediately becomes inaccessible. In other words, the original copy stored in the server 411 and the replica stored in the server 413 are inaccessible at the same time. Accordingly, the DFS of the present invention selects a replicated location of the replica with the method for selecting backup location of the present invention to prevent that the replica is stored in one of the servers 411, 412, 413 under the first switch 31, so as to prevent data lose or unavailable while single point of failure of the first switch 31 occurs.

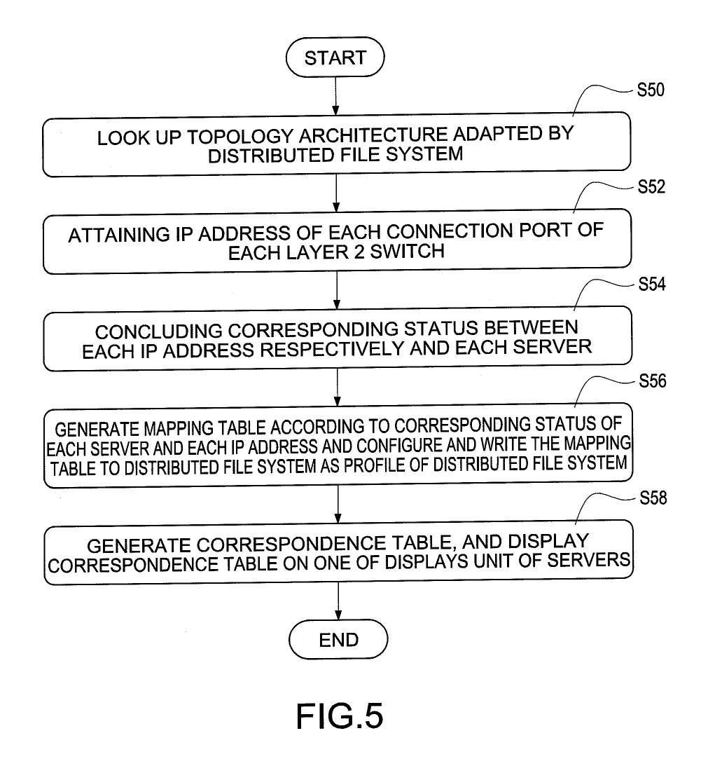

FIG. 5 is a flow chart of a preferred embodiment according to the present invention. Firstly, execute a program and look up topology architecture adapted by the DFS (step S50). As a result, the connection status of each Layer-2/Layer-3 switch 3 and each server 4 in the DFS is attained. It should be mentioned that the program can be but not limited to a Cisco Discovery Protocol (CDP) program from Cisco.

Next, attain the IP address assigned to each connection port of each Layer-2/Layer-3 switch 3 according to the topology architecture of the DFS (step S52). Lastly, after the step S52, assign each IP address to each server 4 (step S54).

After step S54, the system is informed of the connection status between each server 4 respectively and each connection port of a Layer-2/Layer-3 switch 3 and informed of and IP address respectively used by each server 4. Next, generate a mapping table according to the corresponding status of each server 4 and each IP address, and the mapping table is configured and written to the DFS to be a profile of the DFS (step S56). Accordingly, the DFS is always informed of the IP address used by each server 4 after each server 4 slides into the server slot 11 of the system cabinet 1. When the profile is written, the DFS generates replica based on the original copy and stores the replica according to the IP address of each server 4, or references the internal profile in the system to select a best and safest replicated location of the replica.

It should be noted that the above profile is provided to and interpreted by the DFS, it is unreadable by an administrator of the DFS. Even if the profile is manually opened by the administrator, the administrator is not able to know the connection status between each server 4 and each Layer-2/Layer-3 switch 3 according to the content of the profile.

After step S56, the system optionally generates a correspondence table, and displays the correspondence table on a display unit (not shown in the diagram) on one of the servers 4 (step S58). The correspondence table records the text content or number content of the IP address used by each server 4. The administrator can understand the IP address used by each server 4 by seeing the correspondence table, and directly determines the connection status of each server 4 and each Layer-2/Layer-3 switch 3. Yet, the step S58 is optional and may execute depending on the requirement of the administrator of the DFS.

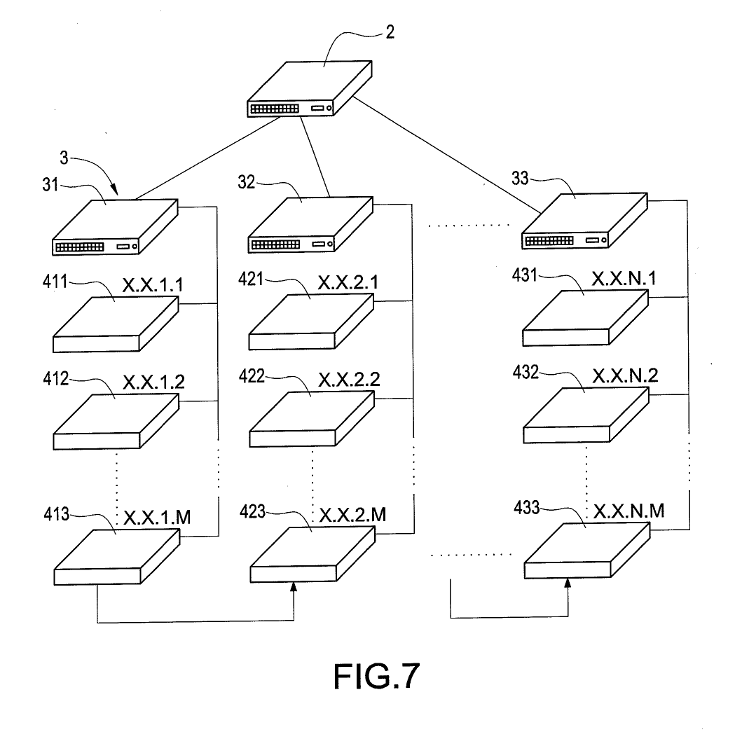

FIG. 7 is a schematic diagram for assigning IP address of a preferred embodiment according to the present invention. A user can understand the IP address assigned to each Layer-2/Layer-3 switch 3 according to the topology architecture of the DFS. For example, the third decimal number of the IP address assigned to each connection port of the first switch 31 is all “1”; the third decimal number of the IP address assigned to each connection port of the second switch 32 is all “2”; and similarly the third decimal number of the IP address assigned to each connection port of the third switch 33 is all “N”. Accordingly, if the IP address of the server 411 expressed by decimal numbers is “X.X.1.1” according to the correspondence table, the IP address of the server 412 is “X.X.1.2”, the IP address of the server 413 is “X.X.1.M”, the user can easily determines according to the correspondence table that the three servers 411, 412, 413 are connected to the same switch via physical wire, which are connected to the first switch 31.

In another example, if the IP address of the server 421 displayed according to the correspondence table by decimal numbers is “X.X.2.1”, and the IP address of the server 432 is “X.X.N.2”, it indicates that the server 421 and 432 are connected to different Layer-2/Layer-3 switches 3. If the original copy is stored in the server 421, the server 432 can be used by the system or the administrator as the replicated location to store the replica. The IP address configuration is provided as a preferred embodiment of the present invention, but not limited thereto.

Further, the system sets up replica generating rules with the profile. For example, the server 411 used for storing the original copy has the IP address “X.X.1.1”, the replica is stored in a different location of another server having the IP address “X.X.1+1.1”, which is the server 421 with the IP address “X.X.2.1”. When the server 412 with the IP address “X.X.1.2” is used for storing the original copy, the replica is stored in a different location of another server having the IP address “X.X.1+1.2”, which is the server 422 with the IP address “X.X.2.2”. When the server with the IP address “X.X.N−1.M” (not shown in the diagram) is used for storing the original copy, the replica is stored in a different location of another server 433 with the IP address “X.X.N.M”.

The replica generating rules are applied in a preferred embodiment of the present invention and are not limited thereto.

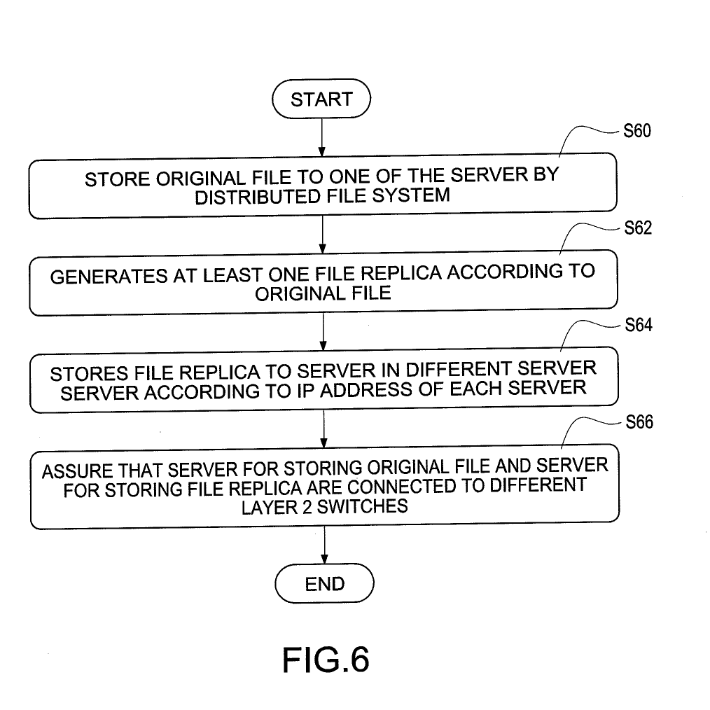

FIG. 6 is a flow chart of a preferred embodiment according to the present invention. When user wants to write a file, the DFS regards the file as an original copy, and stores the original copy to one of the servers 4 (step S60). Next, the DFS generates at least one replica based on the original copy (step S62). After the step S62, the system stores the replica to a server in a location different from the server 4 used for storing the original copy according to the IP address used by each server 4 or the reference provided by the profile (step S64). The system automatically screens and selects according to the IP address of each server 4 or the profile. Or the administrator selects manually according to the correspondence table so as to assure that the server for storing the original copy, and the server for storing the replica are connected to different Layer-2/Layer-3 switches 3 (step S66). Also, the system assures that either the original copy or the replica is accessible once one of the Layer-2/Layer-3 switches 3 fails, and the multiple servers connected to the failed Layer-2/Layer-3 switch 3 immediately become inaccessible.

Accordingly, when one of the server 4 in the DFS fails and the original copy in the failed server 4 is lost or unavailable, the user is allowed to access to the replica in the different location of the other server. If one of the Layer-2/Layer-3 switches 3 fails and multiple servers 4 connected to the failed Layer-2/Layer-3 switch 3 become inaccessible, the user is allowed to access to the original copy or the replica because the server for storing the original copy and the server storing the replica do not connect to the same Layer-2/Layer-3 switch.

As the skilled person will appreciate, various changes and modifications can be made to the described embodiments. It is intended to include all such variations, modifications and equivalents which fall within the scope of the invention, as defined in the accompanying claims.

What is claimed is:

1. A method for selecting backup location used by a DFS, the DFS having multiple Layer-2/Layer-3 switches, each Layer-2/Layer-3 switch respectively having multiple connection ports, and each connection port respectively used for connecting to a server, the method for selecting backup location used by the DFS comprising:
a) looking up the topology architecture of the DFS;
b) attaining the assigned Internet Protocol (IP) address of each connection port of each Layer-2/Layer-3 switch from the topology architecture;
c) assigning each IP address respectively to each server interconnected with each port of each Layer-2/Layer-3 switch;
d) generating at least one replica based on an original copy; and
e) storing the at least one replica in one of the server according to the IP address of each server, wherein the server for storing the original copy and the server for storing the replica are connected to different the Layer-2/Layer-3 switches.

2. The method for selecting backup location used by the DFS of claim 1, wherein the topology architecture of the DFS is tree topology architecture.

3. The method for selecting backup location used by the DFS of claim 1, wherein the topology architecture of the DFS is mesh topology architecture.

4. The method for selecting backup location used by the DFS of claim 1, wherein the topology architecture of the DFS is tree topology with trunking architecture.

5. The method for selecting backup location used by the DFS of claim 1, wherein further comprising a step f: following step c, generating a correspondence table, and displaying the correspondence table on a display unit of one of the servers, wherein the correspondence table records text content or number content of the IP address used by each server.

6. The method for selecting backup location used by the DFS of claim 1, wherein further comprising a step g: following step c, generating a mapping table according to the corresponding status of each server and each IP address and configuring and writing the mapping table to the DFS to be a profile of the DFS where the profile is used for selecting a replicated location of the replica in the step e.

7. The method for selecting backup location used by the DFS of claim 1, wherein in the step a, a Cisco discovery protocol (CDP) program is used for looking up the topology architecture of the DFS.

8. A method for selecting backup location used by a DFS, the DFS having multiple Layer-2/Layer-3 switches, each Layer-2/Layer-3 switch respectively having multiple connection ports, and each connection port respectively used for connecting to a server, the method for selecting backup location used by the DFS comprising:
a) generating a mapping table according to the corresponding status of each server and each IP address;
b) configuring and writing the mapping table to the DFS to be a profile of the DFS;
c) generating at least one replica based on an original copy; and
d) selecting a replicated location of the replica based on the profile, wherein the server for storing the original copy and the server for storing the replica are connected to different the Layer-2/Layer-3 switches.

9. The method for selecting backup location used by the DFS of claim 8, wherein the method comprises steps before the step a:
a01) assigning the IP address assigned to each connection port of each Layer-2/Layer-3 switch to the server interconnected with each connection port.

10. The method for selecting backup location used by the DFS of claim 9, wherein the method comprises steps before the step a01:
a02) looking up the topology architecture of the DFS; and
a03) attaining the assigned Internet Protocol (IP) address of each connection port of each Layer-2/Layer-3 switch from the topology architecture.

11. The method for selecting backup location used by the DFS of claim 10, wherein further comprising a step a04: generating a correspondence table, and displaying the correspondence table on a display unit of one of the servers, wherein the correspondence table records text content or number content of the IP address used by each server.

12. The method for selecting backup location used by the DFS of claim 10, wherein in the step a02, a Cisco discovery protocol (CDP) program is used for looking up the topology architecture of the DFS.

13. The method for selecting backup location used by the DFS of claim 10, wherein the topology architecture of the DFS is tree topology architecture.

14. The method for selecting backup location used by the DFS of claim 10, wherein the topology architecture of the DFS is mesh topology architecture.

15. The method for selecting backup location used by the DFS of claim 10, wherein the topology architecture of the DFS is tree topology with trunking architecture.

16. A DFS, comprising:
at least one main switch;
multiple Layer-2/Layer-3 switches, respectively connecting to at least one main switch, wherein each Layer-2/Layer-3 switch respectively has multiple connection ports, and each connection port respectively is assigned an IP address, where each IP address does not change after each IP address is respectively assigned to each connection port; and
multiple servers, respectively connecting to each connection port of each Layer-2/Layer-3 switch, and connecting to a network via the IP address assigned to the connection port;
wherein, at least one profile is stored in the DFS, the corresponding status of each server and each IP address is recorded in the profile, when the DFS generates at least one replica based on an original copy, and the replica is stored in one of the servers with reference to the profile, wherein the server for storing the original copy and the server for storing the replica are connected to different the Layer-2/Layer-3 switches.

17. The DFS of claim 16, wherein the topology architecture of the DFS is tree topology architecture.

18. The DFS of claim 16, wherein the topology architecture of the DFS is mesh topology architecture.

19. The DFS of claim 16, wherein the topology architecture of the DFS is tree topology with trunking architecture.

20. The DFS of claim 16, wherein the DFS has a correspondence table, the correspondence table records text content or number content of the IP address used by each server, and the correspondence table is displayed on a display unit on at least one of the servers.
